(19) United States
(12) Patent Application Publication
(10) Pub. No.: US 2008/0241617 A1
(43) Pub. Date: Oct. 2, 2008

(54) FUEL CELL

(76) Inventor: Yuusuke SATO, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/054,866

(22) Filed: Mar. 25, 2008

(30) Foreign Application Priority Data
Mar. 28, 2007 (JP) 2007-086017

(51) Int. Cl. H01M 8/04

(52) U.S. Cl. 429/22; 429/34

(57) ABSTRACT

A fuel cell includes a gas discharge passage structure which includes one end portion connected to a liquid fuel supply passage structure in an anode electrode side of an electrolytic membrane and the other end portion opened to an outer space, the one end portion configured to separate gas and liquid from each other, and a gas-liquid separation accelerating structure increasing a pressure of a liquid fuel in the liquid fuel supply passage structure in the anode side of the membrane higher than a pressure of a gas at the one end portion of the gas discharge passage structure, and discharging a gas which is produced from the fuel in the anode side of the membrane and which is not passed through the membrane, from the liquid fuel supply passage structure in the anode side of the membrane to the one end portion of the gas discharge passage structure.

### CROSS-REFERENCE TO RELATED APPLICATIONS

This application is based upon and claims the benefit of priority from prior Japanese Patent Application No. 2007-086017, filed Mar. 28, 2007, the entire contents of which are incorporated herein by reference.

### BACKGROUND OF THE INVENTION

1. Field of the Invention

This invention relates to a fuel cell.

2. Description of the Related Art

There is a known fuel cell comprising: a membrane electrode assembly which includes an electrolytic membrane, and an anode electrode and a cathode electrode arranged in both sides of the electrolytic membrane; a liquid fuel supply passage structure which supplies liquid fuel to the anode electrode side of the electrolytic membrane in the membrane electrode assembly; an air supply passage structure which supplies air to the cathode electrode side of the electrolytic membrane in the membrane electrode assembly; and a liquid discharge passage structure which discharges liquid produced in the cathode electrode side of the electrolytic membrane in the membrane electrode assembly. The known fuel cell uses, for example a mixture of methanol (CH₃OH) and water (H₂O) as the liquid fuel.

In such a conventional fuel cell, the methanol and water of the liquid fuel supplied from a liquid fuel tank to the anode electrode side of the electrolytic membrane through the liquid fuel supply passage structure react to a catalyst provided on the anode electrode side of the electrolytic membrane in the membrane electrode assembly, and emit carbon dioxide (CO₂), hydrogen ions (H⁺) and electrons (e⁻), as shown in the following.

CH₃OH+H₂O→CO₂+6H⁺+6e⁻

The electrons (e⁻¹) move from the anode electrode to the cathode electrode through an electric wire connecting these electrodes.

The hydrogen ions (H⁺) permeate the electrolytic membrane from the anode electrode side to the cathode electrode side, and react to oxygen (O₂) in the air supplied to the cathode electrode side of the electrolytic membrane of the membrane electrode assembly through the air supply passage structure, by a catalyst provided on the cathode electrode side of the electrolytic membrane, and becomes water (H₂O), as shown in the following.

3/2O₂+6H⁺+6e⁻→3H₂O

The water produced in the cathode electrode side of the electrolytic membrane of the membrane electrode assembly is discharged to the outside of the membrane electrode assembly through the liquid discharge passage structure, and then is returned to the liquid fuel tank. A fuel tank for replenishment, which stores methanol having higher concentration than that of the liquid fuel in the liquid fuel tank, is connected to the fuel tank. When the methanol concentration of the liquid fuel in the liquid fuel tank decreases lower than a predetermined value, a predetermined amount of the high-concentration methanol is supplied from the fuel tank for replenishment to the liquid fuel tank, and the methanol concentration of the liquid fuel in the liquid fuel tank regains a predetermined value.

In such a conventional fuel cell, the carbon dioxide (CO₂) produced in the anode electrode side of the electrolytic membrane in the membrane electrode assembly, together with unreacted liquid fuel in the anode electrode side of the electrolytic membrane in the membrane electrode assembly, is discharged to the outside of the membrane electrode assembly through a liquid fuel returning passage structure. An outer end of the liquid fuel returning passage structure is connected to a gas-liquid separator, and the unreacted liquid fuel, the carbon dioxide (CO₂) and organic gas evaporated from the unreacted liquid fuel are separated from each other by the gas-liquid separator.

The unreacted liquid fuel is mixed with a fresh liquid fuel, and is supplied again to the anode electrode side of the electrolytic membrane through the liquid fuel supply passage structure in the membrane electrode assembly. The carbon dioxide (CO₂) and the organic gas are discharged to an outer space through an organic matter eliminating device.

JP-A 2005-518646 (KOHYO) discloses a fuel cell which separates carbon dioxide (CO₂) produced in an anode electrode side of an electrolytic membrane from unused liquid fuel in the anode electrode side of the electrolytic membrane by a gas permeable membrane provided in the anode electrode side of the electrolytic membrane in a membrane electrode assembly.

In the above-mentioned former conventional fuel cell, the gas-liquid separator is arranged away from the membrane electrode assembly. Therefore, its entire outer dimensions are large, a choice of installation places for the former conventional fuel cell is narrowed, and its manufacturing cost is high. Further, a distance for circulation of the liquid fuel in the anode electrode side of the electrolytic membrane in the membrane electrode assembly is long, so that a pressure loss of the liquid fuel is large. That is, the operation efficiency of the fuel cell is lowered.

In the latter conventional fuel cell described in JP-A 2005-518646 (KOHYO), the separation of the carbon dioxide (CO₂) produced in the anode electrode side of the electrolytic membrane from the unused liquid fuel in the anode electrode side of the electrolytic membrane through the gas permeable membrane provided in the anode electrode side of the electrolytic membrane in the membrane electrode assembly is performed by only a small pressure of the liquid fuel flowing into the anode electrode side of the electrolytic membrane in the membrane electrode assembly. Therefore, the separation efficiency of the carbon dioxide (CO₂) from the unused liquid fuel in the anode electrode of the electrolytic membrane in the membrane electrode assembly is low, and it is easily influenced by changes in a posture of the fuel cell with respect to the direction of the gravity.

### BRIEF SUMMARY OF THE INVENTION

According to one aspect of the present invention, a fuel cell comprising: a membrane electrode assembly including an electrolytic membrane, and an anode electrode and cathode electrode arranged in both sides of the electrolytic membrane; a liquid fuel supply passage structure supplying liquid fuel to the anode electrode side of the electrolytic membrane; an air supply passage structure supplying air to the cathode electrode side of the electrolytic membrane; a gas discharge passage structure including one end portion which is connected to the liquid fuel supply passage structure in the anode electrode side of the electrolytic membrane and the other end portion which is opened to an outer space, the one end portion configured to separate gas and liquid from each other; and a gas-liquid separation accelerating structure increasing a pressure of the liquid fuel in the liquid fuel supply passage structure in the anode electrode side of the electrolytic membrane higher than a pressure of a gas at the one end portion of the gas discharge passage structure, and discharging a gas which is produced from the liquid fuel in the anode electrode side of the electrolytic membrane and which is not passed through the electrolytic membrane, from the liquid fuel supply passage structure in the anode electrode side of the electrolytic membrane to the one end portion of the gas discharge passage structure.

In this fuel cell, the efficiency of separating gas such as carbon dioxide (CO₂) from unused liquid fuel in the anode electrode side of the electrolytic membrane is high, and it is hardly influenced by changes in posture of the fuel cell with respect to the direction of the gravity.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic longitudinal sectional view of a fuel cell according to a first embodiment of the invention;

FIG. 2 is a schematic longitudinal sectional view of a fuel cell according to a second embodiment of the invention;

FIG. 3 is a schematic longitudinal sectional view of a fuel cell according to a third embodiment of the invention;

FIG. 4 is a schematic longitudinal sectional view of a fuel cell according to a fourth embodiment of the invention;

FIG. 5 is a schematic longitudinal sectional view of a fuel cell according to a fifth embodiment of the invention;

FIG. 6 is a schematic longitudinal sectional view of an essential part of a fuel cell according to a sixth embodiment of the invention;

FIG. 7 is a schematic longitudinal sectional view of a fuel cell according to a seventh embodiment of the invention;

FIG. 8 is a schematic longitudinal sectional view of a fuel cell according to an eighth embodiment of the invention; and

FIG. 9 is a schematic longitudinal sectional view of a fuel cell according to a ninth embodiment of the invention.

### DETAILED DESCRIPTION OF THE INVENTION

### First Embodiment

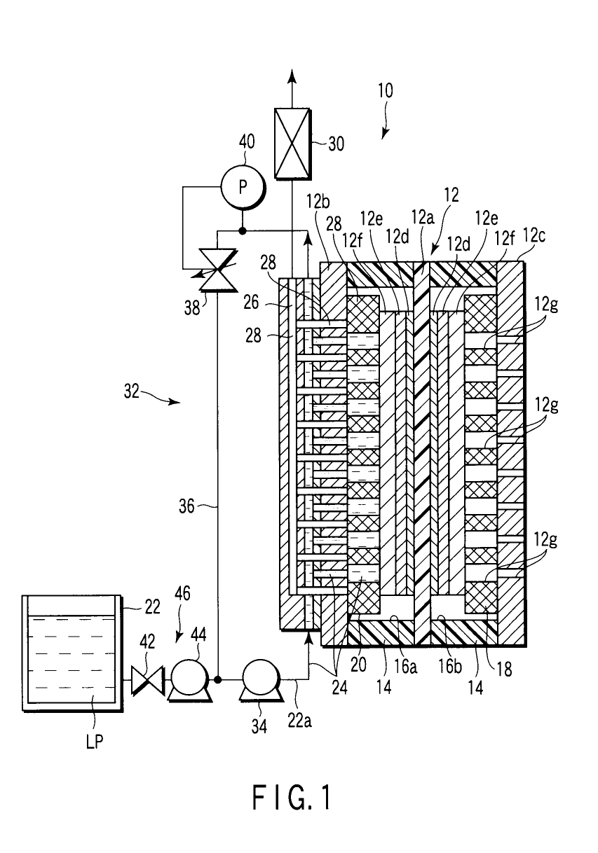

As shown in FIG. 1, a fuel cell 10 according to a first embodiment of this invention comprises a membrane electrode assembly 12 including an electrolytic membrane 12a, and an anode electrode 12b and cathode electrode 12c arranged in both sides of the electrolytic membrane 12a. In the membrane electrode assembly 12, peripheral edges of both sides of the electrolytic membrane 12a and the peripheral edges of the anode electrode 12b and cathode electrode 12c in both sides of the electrolytic membrane 12a are sealed with sealing members 14, so that an anode chamber 16a is provided between the electrolytic membrane 12a and the anode electrode 12b and a cathode chamber 16b is provided between the electrolytic membrane 12a and the cathode electrode 12c.

In the anode chamber 16a and cathode chamber 16b, the electrolytic membrane 12a includes catalyst layers 12d on its both surfaces. On the catalyst layer 12d, a micro porous layer 12e having an electrical conductivity, for example a porous carbon, and a gas diffusing layer 12f having an electrical conductivity, for example a carbon paper, are laminated.

In the cathode electrode 12c, many through holes are formed to extend between the cathode chamber 12b and the outer space. In the cathode chamber 16b, a conductive interposing member 18 is provided between the gas diffusing layer 12f and cathode electrode 12c. Also, in the interposing member 18, many through holes are formed to extend between the cathode electrode 12c and the gas diffusing layer 12f so as to correspond to the through holes of the cathode electrode 12c. The through holes of the cathode electrode 12c and the through holes of the interposing member 18 configure air supply passages 12g to supply air from the outer space to the cathode electrode side of the electrolytic membrane 12a in the membrane electrode assembly 12.

In the anode electrode 12b, many first through holes are formed to extend between the anode chamber 16a and the outer space. Further, in the anode electrode 12b, many second through holes are formed independent of the first through holes to extend between the anode chamber 16a and the outer space. In the anode chamber 16a, a conductive micro passage member 20 is interposed between the gas diffusing layer 12f and the anode electrode 12b. The micro passage member 20 has many micro passages, and can be a so-called porous member. However, the micro passage member 20 may have a configuration to provide many micro passages by weaving or interlocking fibers.

Also, in the micro passage member 20, many through holes are formed to extend between the anode electrode 12b and the gas diffusing layer 12f so as to correspond to the first through holes of the anode electrode 12b. Outer ends of the first through holes of the anode electrode 12b are connected to a liquid fuel supply pipe 22a from a liquid fuel tank 22. In this embodiment, the liquid fuel tank 22 stores a methanol as a liquid fuel LP, and the methanol is a kind of hydrocarbon and has a relatively high concentration. Here, the methanol that is a kind of hydrocarbon may be diluted by water.

Therefore, in this embodiment, the liquid fuel supply pipe 22a, the first through holes of the anode electrode 12b and the through holes of the micro passage member 20 configure a liquid fuel supply passage structure 24 to supply the liquid fuel LP to the anode electrode side of the electrolytic membrane 12a in the membrane electrode assembly 12.

The liquid fuel LP (methanol (CH₃OH) with a relatively high concentration in this embodiment) supplied from the fuel tank 22 through the liquid fuel supply passage structure 24 to the anode electrode side of the electrolytic membrane 12a in the membrane electrode assembly 12 emits carbon dioxide (CO₂), hydrogen ions (H⁺) and electrons (e⁻¹), as described before.

CH₃OH+H₂O→CO₂+6H⁺+6e⁻

The electrons (e⁻¹) move from the anode electrode 12b to the cathode electrode 12c through an electric wire connecting these electrodes 12b and 12c. The hydrogen ions (H⁺) permeate the electrolytic membrane 12a from the anode electrode 12b to the cathode electrode 12c, and react to oxygen (O₂) in the air supplied to the cathode electrode side of the electrolytic membrane 12d of the membrane electrode assembly 12 through the air supply passage structure 12g, by a catalyst 12d provided on the cathode electrode side of the electrolytic membrane 12a, and becomes water (H₂O), as shown in the following.

3/2O₂+6H⁺+6e⁻→3H₂O

The water produced in the cathode electrode side of the electrolytic membrane 12a of the membrane electrode assembly 12 is discharged to the outer space from the air supply passage structure 12g, as a liquid, or after being evaporated.

If the gas (carbon dioxide (CO₂) in this embodiment) produced as described above from the liquid fuel LP in the anode electrode side of the electrolytic membrane 12a in the membrane electrode assembly 12 is not be discharged to the outer space, the liquid fuel LP (ethanol (CH₃OH) with relatively high concentration in this embodiment) supplied to the anode electrode side of the electrolytic membrane 12a in the membrane electrode assembly 12 through the liquid fuel supply passage structure 24 will be prevented from contacting the catalysis layer 12d in the anode electrode side of the electrolytic membrane 12a by the above described gas so that the fuel cell 10 will not be able to generate electric power.

Therefore, the fuel cell 10 has a gas discharge passage structure to discharge the gas (carbon diode (CO₂) in this embodiment) produced as described above from the liquid fuel LP in the anode electrode side of the electrolytic membrane 12a in the membrane electrode assembly 12 to the outer space.

Specifically, the micro passage member 20 needs to have at least one of a hydrophobic nature or a water-repellency. In this embodiment, the micro passage member 20 is made of a conductive water-repellent material, for example, carbon, and is treated to have a water-repellency. Inner ends of the second through holes of the anode electrode 12b are opposed to many parts of the liquid fuel supply passage structure 24 at which the through holes are not formed. Outer ends of the second through holes of the anode electrode 12b are connected to one end portion of a gas discharge pipe 26 which is independent of the liquid fuel supply pipe 22a of the liquid fuel supply passage structure 24. The other end portion of the gas discharge pipe 26 is opened to the outer space through an organic matter eliminating filter 30.

Therefore, in this embodiment, the innumerable micro holes of the micro passage member 20, many second through holes of the anode electrode 12b, and the gas discharge pipe 26 configure a gas discharge passage structure 28 which includes one end portion connected to the liquid fuel supply passage structure 24 in the anode electrode side of the electrolytic membrane 12a of the membrane electrode assembly 12 and the other end portion opened to the outer space.

Since the micro passage member 20 configuring the above descried one end portion of the gas discharge passage structure 28 has at least one of the hydrophobic nature and the water-repellency, the micro passage member 20 prevents the liquid fuel in the through holes of the micro passage member 20 that is a part of the liquid fuel supply passage structure 24 from flowing into the innumerable micro holes of the micro passage member 20. However, gas can pass through the innumerable micro holes. This means that the micro passage member 20 providing the above described one end portion of the gas discharge passage structure 28 is configured to separate gas and liquid from each other.

The fuel cell 10 has a gas-liquid separation accelerating structure 32. The gas-liquid separation accelerating structure 32 discharges the gas (carbon dioxide (CO₂) in this embodiment) which is produced from the liquid fuel LP in the anode electrode side of the electrolytic membrane 12a in the membrane electrode assembly 12 and does not pass through the electrolytic membrane 12a, from the liquid fuel supply passage structure 24 in the anode electrode side of the electrolytic membrane 12a in the membrane electrode assembly 12, to the one end portion of the gas discharge passage structure 28, by increasing the pressure of the liquid fuel LP in the liquid fuel supply passage structure 24 in the anode electrode side of the electrolytic membrane 12a in the membrane electrode assembly 12 higher than the pressure of the gas (carbon dioxide (CO₂) in this embodiment) at the one end portion of the gas discharge passage structure 28.

In this embodiment, a liquid fuel pressurizing unit 34 is interposed in the liquid fuel supply passage structure 24. The liquid fuel pressurizing unit 34 can be provided with a presser pump, for example. The fuel cell 10 is further provided with a liquid fuel returning passage structure 36. The liquid fuel returning passage structure 36 has one end portion connected to the liquid fuel supply passage structure 28 in the anode electrode side of the electrolytic membrane 12a in the membrane electrode assembly 12, and the other end portion connected to the liquid fuel supply passage structure 24 between the liquid fuel tank 22 and the liquid pressuring unit 34 in the outside of the membrane electrode assembly 12. The liquid fuel returning passage structure 36 returns unreacted liquid fuel LP in the anode electrode side of the electrolytic membrane 12a in the membrane electrode assembly 12 to the liquid fuel supply passage structure 22a.

A back-pressure valve 38 is interposed in the liquid fuel returning passage structure 36, and a pressure gauge unit 40 is further interposed in the liquid fuel returning passage structure 36 between the back-pressure valve 38 and the above described one end portion in the membrane electrode assembly 12. The pressure gauge unit 40 is configured to control opening/closing of the back-pressure valve 38, and opens the back-pressure valve 38 when the pressure gauge unit 40 detects a pressure higher than a predetermined value, and closes the back-pressure valve 38 while the pressure gauge unit 40 detects a pressure lower than the predetermined value.

An on-off valve 42 and a pressure pump 44 are interposed in the liquid fuel supply passage structure 24 between the liquid fuel tank 22 and the other end portion of the liquid fuel returning passage structure 36.

In the fuel cell 10 configured as described above and according to the first embodiment, the pressure of the liquid fuel LP included in a part of the liquid fuel supply passage structure 22a from the liquid fuel pressurizing unit 34 to the anode electrode side of the electrolytic membrane 12a in the membrane electrode assembly 12, and also included in a part of the liquid fuel returning passage structure 36 from the anode electrode side of the electrolytic membrane 12a in the membrane electrode assembly 12 to the back pressure valve 38, is always kept at a predetermined value by the pressure gauge unit 40. Namely, the pressure of the liquid fuel LP in the liquid fuel supply passage structure 24 in the anode electrode side of the electrolytic membrane 12a in the membrane electrode assembly 12 is always increased by a predetermined value higher than the pressure of the gas (carbon dioxide (CO₂) in this embodiment) in the micro passage member 20 that is one end portion of the gas discharge passage structure 28 connected to the liquid fuel supply passage structure 24 in the anode electrode side of the electrolytic membrane 12a.

This means that a combination of the liquid fuel pressurizing unit 34 interposed in the liquid fuel supply passage structure 24 and the liquid fuel returning passage structure 36 provided with the back pressure valve 38 and pressure gauge unit 40 configures the gas-liquid separation accelerating structure 32 in this embodiment.

Therefore, the gas (carbon dioxide (CO₂) in this embodiment) produced as described above in the anode electrode side of the electrolytic membrane 12a in the membrane electrode assembly 12 can be discharged easily into the micro passage member 20 that is the one end portion of the gas discharge passage structure 28 connected to the liquid fuel supply passage structure 24 in the anode electrode side of the electrolytic membrane 12a, and is hard to be included in the liquid fuel LP in the anode electrode side of the electrolytic membrane 12a in the membrane electrode assembly 12, so that the discharging of the gas is accelerated. This acceleration is performed irrespectively of the posture of the fuel cell 10.

As the gas (carbon dioxide (CO₂) in this embodiment) is separated from the unused liquid fuel LP in the anode electrode side of the electrolytic membrane 12a in the membrane electrode assembly 12, the outer dimensions of the entire fuel cell 10 can be reduced to much smaller than those of the conventional fuel cell described before in which the separation is performed in the outside of the fuel cell, and the manufacturing cost can be reduced. Further, as the pressure of the liquid fuel LP in the liquid fuel supply passage structure 24 in the anode electrode side of the electrolytic membrane 12a in the membrane electrode assembly 12 is always increased by a predetermined value higher than the pressure of the gas (carbon dioxide (CO₂) in this embodiment) in the micro passage member 20 that is the one end portion of the gas discharge passage structure 28 connected to the liquid fuel supply passage structure 24 in the anode electrode side of the electrolytic membrane 12a, the efficiency of the above described separation is much increased, and the separation is not influenced by changes in the posture of the fuel cell 10 with respect to the direction of the gravity.

In this embodiment, the on-off valve 42 and pressure pump 44 in the liquid fuel supply passage structure 24 opens and operates for a predetermined time at predetermined intervals. Therefore, it is possible to replenish fresh liquid fuel LP from the liquid fuel tank 22 by the amount equivalent to that of the liquid fuel LP consumed in the anode electrode side of the electrolytic membrane 12a in the membrane electrode assembly 12 at every predetermined interval.

Namely, by combining the on-off valve 42 and the pressure pump 44 with a liquid fuel supply source such as the liquid fuel tank 22, these configure a liquid fuel replenish unit 46, which replenishes the liquid fuel LP from the liquid fuel supply source such as the liquid fuel tank 22 to the liquid fuel supply passage structure 24.

### Second Embodiment

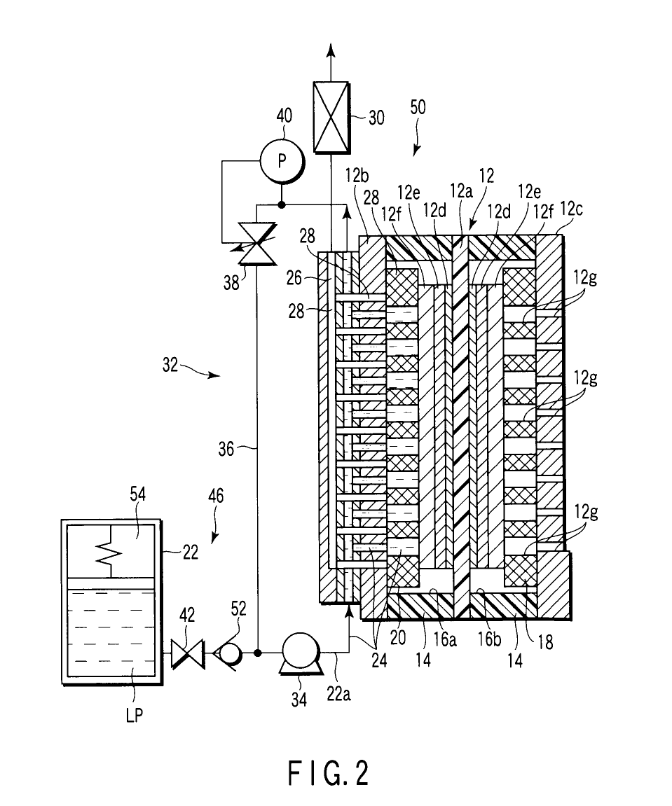

Most part of structural elements of a fuel cell 50 according to a second embodiment of the present invention shown in FIG. 2 is the same as that of the structural elements of the fuel cell 10 according to the first embodiment described hereinbefore with reference to FIG. 1. Therefore, the structural elements of the fuel cell 50 which are the same as those of the fuel cell 10 of the first embodiment are denoted by the same reference numerals as those denoting the structural elements of the fuel cell 10 corresponding to those of the fuel cell 50, and detailed explanation on these structural elements will be omitted.

The fuel cell 50 of this embodiment is different from the fuel cell 10 of the first embodiment described above with reference to FIG. 1 in that a check valve 52 is interposed in the liquid fuel supply passage structure 24 between the liquid fuel tank 22 and the other end of the liquid fuel returning passage structure 36, instead of the pressure pump 44 used in the fuel cell 10 of the first embodiment shown in FIG. 1, and that the liquid fuel tank 22 uses a liquid fuel pressure loading unit 54 configured to load a predetermined pressure to the liquid fuel LP in the liquid fuel tank 22. The liquid fuel pressure loading unit 54 can be a combination of a piston member provided in the liquid fuel tank 22, and an urging means such as a compression spring interposed between the piston member and the inner surface of the liquid fuel tank 22.

In this embodiment, the on-off valve 42 of the liquid fuel supply passage structure 24 is opened for a predetermined time at every predetermined interval. Therefore, fresh liquid fuel LP in the liquid fuel tank 22 is replenished through the check vale 52 by the pressure loaded by the liquid fuel pressure loading unit 54 at every predetermined interval, by the amount equivalent to that of the liquid fuel LP consumed in the anode electrode side of the electrolytic membrane 12a in the membrane electrode assembly 12.

Namely, the on-off valve 42, the check valve 52 and the liquid fuel pressure loading unit 54 are combined with a liquid fuel supply source such as the liquid fuel tank 22, and configure the liquid fuel replenish unit 46 which replenishes the liquid fuel LP from the liquid fuel supply source such as the liquid fuel tank 22 to the liquid fuel supply passage structure 24.

As the liquid fuel replenish unit 46 of the fuel cell 50 according to the second embodiment uses the check valve 52 and liquid fuel pressure loading unit 54 not requiring an artificial power source such as an electric motor or other motors, instead of the pressure pump 44 used in the liquid fuel replenish unit 46 of the fuel cell 10 of the first embodiment shown in FIG. 1, the operation efficiency is high, and the manufacturing costs are low.

### Third Embodiment

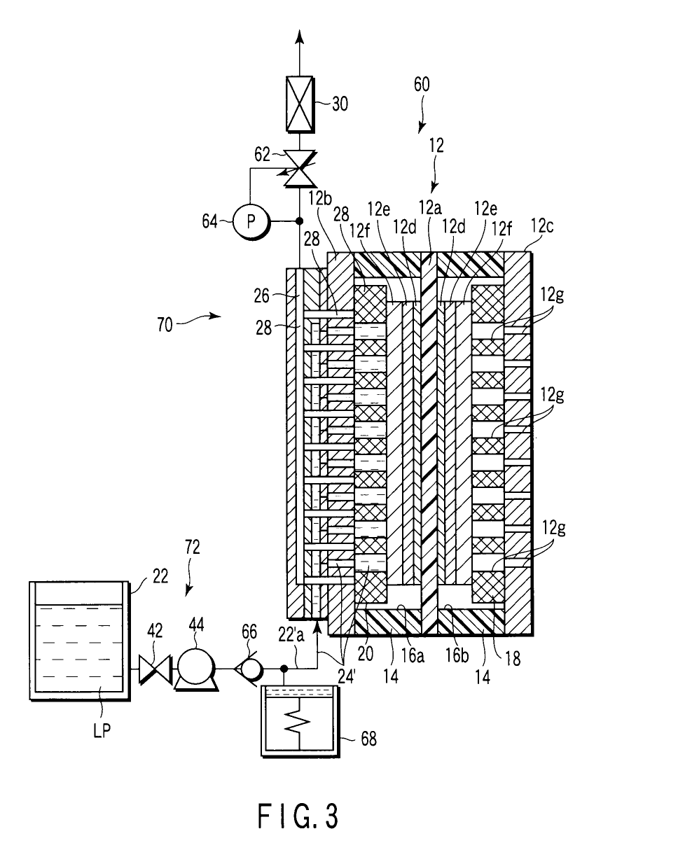

Most part of structural elements of a fuel cell 60 according to a third embodiment of the present invention shown in FIG. 3 is the same as that of the structural elements of the fuel cell 10 according to the first embodiment described hereinbefore with reference to FIG. 1. Therefore, the structural elements of the fuel cell 60 which are the same as those of the fuel cell 10 of the first embodiment are denoted by the same reference numerals as those denoting the structural elements of the fuel cell 10 corresponding to those of the fuel cell 60, and detailed explanation on these structural elements will be omitted.

The fuel cell 60 of this embodiment is different from the fuel cell 10 of the first embodiment described above with reference to FIG. 1 in that the fuel returning passage 36 with the back pressure valve 38 and pressure gauge unit 40 used in the fuel cell 10 of the first embodiment is not used, and that a back pressure valve 62 and a pressure gauge unit 64 are interposed in the gas discharge passage structure 28. The back pressure valve 62 is configured to open when the pressure gauge unit 64 detects a pressure higher than a predetermined value, and to close when the pressure gauge unit 64 detects a pressure lower than the predetermined value.

The fuel cell 60 of this embodiment is further different from the fuel cell 10 of the first embodiment described above with reference to FIG. 1 in the following points.

In a liquid fuel supply pipe 22′a, an on-off valve 42, a pressure pump 44, a check valve 66 and a liquid fuel pressurizing unit 68 are interposed between the liquid fuel tank 22 and the membrane electrode assembly 12 in this order in a flowing direction of the liquid fuel LP in the liquid fuel supply pipe 22′a.

The liquid fuel pressurizing unit 68 can be a combination of a piston member provided in a liquid fuel reservoir interposed in the liquid fuel supply pipe 22′a and an urging means such as a compression spring interposed between the piston member and the inner surface of the liquid fuel reservoir, for example.

The liquid fuel supply pipe 22′a has a part with a reduced inner diameter between the membrane electrode assembly 12 and the liquid fuel pressurizing unit 68. In this embodiment, the inner diameter of each part of the liquid fuel supply pipe 22′a corresponding to the each first through hole of the anode electrode 12b for the liquid fuel LP is reduced.

In this embodiment, the liquid fuel LP from the liquid fuel supply pipe 22′a is supplied to the anode electrode side of the electrolytic membrane 12a in the membrane electrode assembly 12 through the part with the reduced inner diameter. The flowing speed of the liquid fuel LP at the part with the reduced inner diameter is higher than that at a part with a not reduced inner diameter, and the liquid fuel LP is prevented from flowing back to the liquid fuel supply pipe 22′a from the anode electrode side of the electrolytic membrane 12a in the membrane electrode assembly 12. Thus, the water produced in the cathode electrode side of the electrolytic membrane 12a is prevented from penetrating into the anode electrode side and from diluting the liquid fuel in the anode electrode side, so that a reduction of the power generation efficiency of the fuel cell 60 is prevented.

Therefore, in this embodiment, the liquid fuel supply pipe 22′a having the part with the reduced inner diameter, the first through holes of the anode electrode 12b, and the through holes of the micro passage member 20 configure a liquid fuel supply passage structure 24′ to supply a liquid fuel LP to the anode electrode side of the electrolytic membrane 12a in the membrane electrode assembly 12.

In the fuel cell 60 configured as described above and according to the third embodiment, the back pressure valve 38 is opened when the pressure of the gas (carbon dioxide (CO₂) in this embodiment) in the micro passage member 20 that is the one end portion of the gas discharge passage structure 28 connected to the liquid fuel supply passage structure 24′ in the anode electrode side of the electrolytic membrane 12a becomes higher than a predetermined pressure of the liquid fuel LP included in a part of the liquid fuel supply passage structure 22′a from the liquid fuel pressurizing unit 68 to the anode electrode side of the electrolytic membrane 12a in the membrane electrode assembly 12. Namely, the pressure of the liquid fuel LP in the liquid fuel supply passage structure 24′ in the anode electrode side of the electrolytic membrane 12a in the membrane electrode assembly 12 is always increased by a predetermined value higher than the pressure of the gas (carbon dioxide (CO₂) in this embodiment) in the micro passage member 20 that is the one end portion of the gas discharge passage structure 28 connected to the liquid fuel supply passage structure 24′ in the anode electrode side of the electrolytic membrane 12a.

This means that a combination of the liquid fuel pressurizing unit 68 interposed in the liquid fuel supply passage structure 24′, the back pressure valve 62 and pressure gauge unit 64 interposed in the gas discharge passage structure 28 configures a gas-liquid separation accelerating structure 70 in this embodiment.

Therefore, the gas (carbon dioxide (CO₂) in this embodiment) produced as described above in the anode electrode side of the electrolytic membrane 12a in the membrane electrode assembly 12 can be easily discharged into the micro passage member 20 that is the one end portion of the gas discharge passage structure 28 connected to the liquid fuel supply passage structure 24′ in the anode electrode side of the electrolytic membrane 12a, and is hard to be included in the liquid fuel LP in the anode electrode side of the electrolytic membrane 12a in the membrane electrode assembly 12, so that the discharging of the gas is accelerated. This acceleration is performed irrespectively of the posture of the fuel cell 10.

In this embodiment, the on-off valve 42 and pressure pump 44 of the liquid fuel supply passage structure 24′ opens and operates for a predetermined time at every predetermined interval. Therefore, it is possible to replenish a fresh liquid fuel LP from the liquid fuel tank 22 through the check valve 66 at every predetermined interval by the amount equivalent to that of the liquid fuel LP consumed in the anode electrode side of the electrolytic membrane 12a in the membrane electrode assembly 12.

Namely, the on-off valve 42, the pressure pump 44 and the check valve 66 are combined with the liquid fuel supply source such as the liquid fuel tank 22 and configure a liquid fuel replenish unit 72 which replenishes the liquid fuel LP from the liquid fuel supply source such as the liquid fuel tank 22 to the liquid fuel supply passage structure 24′.

### Fourth Embodiment

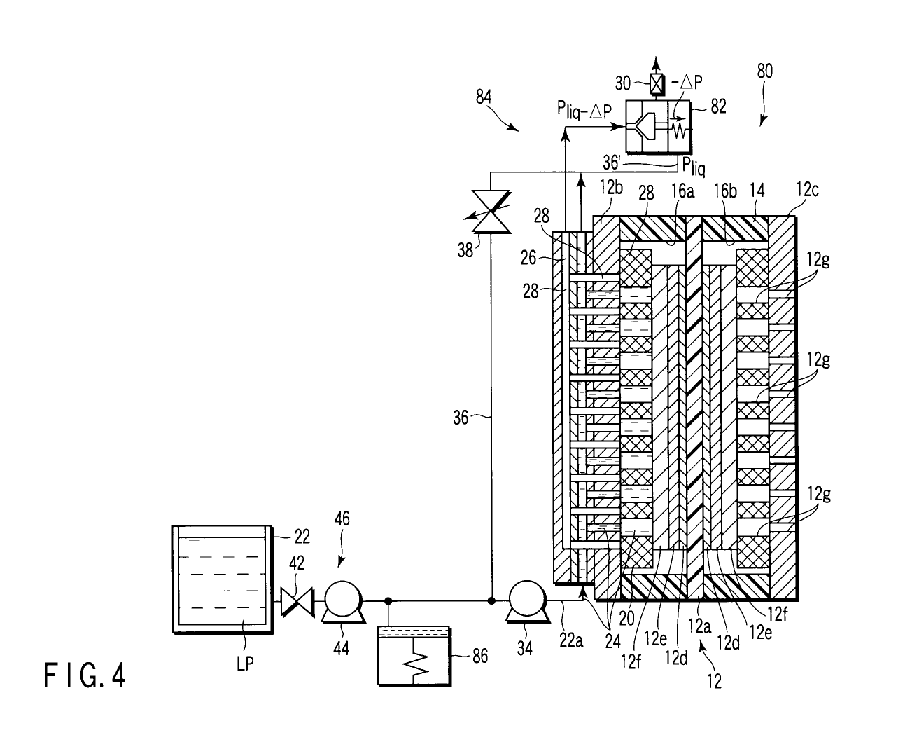

Most part of structural elements of a fuel cell 80 according to a fourth embodiment of the present invention shown in FIG. 4 is the same as that of the structural elements of the fuel cell 10 according to the first embodiment described hereinbefore with reference to FIG. 1. Therefore, the structural elements of the fuel cell 80 which are the same as those of the fuel cell 10 of the first embodiment are denoted by the same reference numerals as those denoting the structural elements of the fuel cell 10 corresponding to those of the fuel cell 80, and detailed explanation on these structural elements will be omitted.

The fuel cell 80 of this embodiment is different from the fuel cell 10 of the first embodiment described above with reference to FIG. 1 in that the pressure gauge unit 40 is not interposed in the fuel returning passage 36, and a pressure regulating unit 82 is interposed in the gas discharge passage structure 28 in the outside of the membrane electrode assembly 12.

The pressure regulating unit 82 is connected to a branch passage 36′ branched from the fuel returning passage 36 between the membrane electrode assembly 12 and the back pressure valve 38. The pressure regulating unit 82 is opened by a pressure obtained by subtracting a predetermined pressure from the pressure of the liquid fuel LP flowing from the branch passage 36′, and passes the gas in the gas discharge passage structure 28.

The back pressure valve 38 is opened when the pressure of the liquid fuel LP in the fuel returning passage 36, or in the liquid fuel supply passage structure 24 in the anode electrode side of the electrolytic membrane 12a in the membrane electrode assembly 12 increases over a predetermined value, and is closed when the pressure is lower than the predetermined pressure.

Therefore, in the fuel battery 80 configured as described above and according to the fourth embodiment, the pressure of the liquid fuel LP included in a part of the liquid fuel supply passage structure 24 from the liquid fuel pressurizing unit 34 to the anode electrode side of the electrolytic membrane 12a in the membrane electrode assembly 12, and included in the part of the liquid fuel returning passage structure 36 from the anode electrode side of the electrolytic membrane 12a in the membrane electrode assembly 12 to the back pressure valve 38, is always kept at a predetermined value.

The pressure regulating unit 82 discharges the gas from the gas discharge passage structure 28 to the outer space, before the pressure of the gas in the gas discharge passage structure 28, or in the micro passage member 20 that is the one end portion of the gas discharge passage structure 28 adjacent to the liquid fuel supply passage structure 24 in the anode electrode side of the electrolytic membrane 12a in the membrane electrode assembly 12, increases to the above predetermined pressure of liquid fuel LP.

Namely, the pressure of the liquid fuel LP in the liquid fuel supply passage structure 24 in the anode electrode side of the electrolytic membrane 12a in the membrane electrode assembly 12 is always increased by a predetermined value higher than the pressure of the gas (carbon dioxide (CO₂) in this embodiment) in the micro passage member 20 that is the one end portion of the gas discharge passage structure 28 connected to the liquid fuel supply passage structure 24 in the anode electrode side of the electrolytic membrane 12a.

This means that a combination of the liquid fuel pressurizing unit 34 interposed in the liquid fuel supply passage structure 24, the liquid fuel returning passage structure 36 provided with the back pressure valve 38, and the pressure regulating unit 82 which is interposed in the gas discharge passage structure 28 and which is normally opened by a pressure obtained by subtracting a predetermined pressure from the pressure of the liquid fuel LP from the branch passage 36′ of the liquid fuel returning passage structure 36, configures the gas-liquid separation accelerating structure 84 in this embodiment.

Therefore, the gas (carbon dioxide (CO₂) in this embodiment) produced as described above in the anode electrode side of the electrolytic membrane 12a in the membrane electrode assembly 12, is discharged easily into the micro passage member 20 that is the one end portion of the gas discharge passage structure 28 connected to the liquid fuel supply passage structure 24 in the anode electrode side of the electrolytic membrane 12a, and is included hardly in the liquid fuel LP in the anode electrode side of the electrolytic membrane 12a in the membrane electrode assembly 12. Therefore, the discharging of the gas is accelerated. This acceleration is performed irrespectively of the posture of the fuel cell 80.

In this embodiment, an auxiliary liquid fuel replenish unit 86 is interposed in the liquid fuel supply passage structure 24 between the pressure pump 44 of the liquid fuel replenish unit 46 and a connecting point of the liquid fuel returning passage structure 36. The auxiliary liquid fuel replenish unit 86 can be a combination of a piston member provided in a liquid fuel reservoir interposed in the liquid fuel supply pipe 22a and an urging means such as a compression spring interposed between the piston member and the inner surface of the liquid fuel reservoir, for example. Such an auxiliary liquid fuel replenish unit 86 reduces the operation period of the liquid fuel replenish unit 46 configured by the pressuring pump 44 and the on-off valve 42 both of which are combined with the liquid fuel supply source such as the liquid fuel tank 22, and improves the operation efficiency of the fuel cell 80 of this embodiment.

### Fifth Embodiment

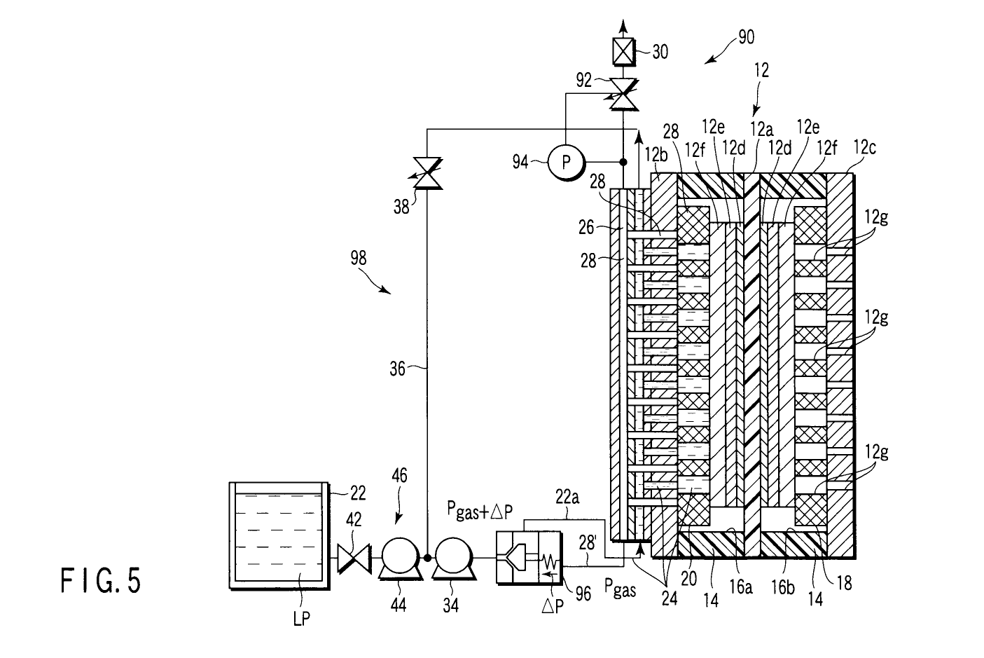

Most part of structural elements of a fuel cell 90 according to a fifth embodiment of the present invention shown in FIG. 5 is the same as that of the structural elements of the fuel cell 10 according to the first embodiment described hereinbefore with reference to FIG. 1. Therefore, the structural elements of the fuel cell 90 which are the same as those of the fuel cell 10 of the first embodiment are denoted by the same reference numerals as those denoting the structural elements of the fuel cell 10 corresponding to those of the fuel cell 90, and detailed explanation on these structural elements will be omitted.

The fuel cell 90 of this embodiment is different from the fuel cell 10 of the first embodiment described above with reference to FIG. 1 in that the pressure gauge unit 40 is not interposed in the fuel returning passage 36, and a back pressure valve 92 and a pressure gauge unit 94 are interposed in the gas discharge passage structure 28 in the outside of the membrane electrode assembly 12. The back pressure valve 92 is configured to be opened when the pressure gauge unit 94 detects a pressure higher than a predetermined value, and to be closed when the pressure gauge unit 94 detects a pressure lower than the predetermined value.

The fuel cell 90 of this embodiment is further different from the fuel cell 10 of the first embodiment described above with reference to FIG. 1 in the following points.

A pressure regulating unit 96 is interposed in the liquid fuel supply pipe 22a of the liquid fuel supply passage structure 24 between the membrane electrode assembly 12 and the liquid fuel pressurizing unit 34. The pressure regulating unit 96 is connected to a branch passage 28′ branched from the gas discharge passage structure 28. The pressure regulating unit 96 closes the liquid fuel supply pipe 22a by a pressure obtained by adding a predetermined pressure to the pressure of the gas from the branch passage 28′, and stops the passing of liquid fuel LP in the liquid fuel supply pipe 22a.

The back pressure valve 38 opens when the pressure of the liquid fuel LP in the fuel returning passage 36, or in the liquid fuel supply passage structure 24 in the anode electrode side of the electrolytic membrane 12a in the membrane electrode assembly 12, increases over a predetermined value, and closes when the pressure is lower than the predetermined value.

Therefore, in the fuel cell 90 configured as described above and according to the fifth embodiment, the pressure of liquid fuel LP included in the part of the liquid fuel supply passage structure 24 from the liquid fuel pressurizing unit 34 to the anode electrode side of the electrolytic membrane 12a in the membrane electrode assembly 12, and in the part of the liquid fuel returning passage structure 36 from the anode electrode side of the electrolytic membrane 12a in the membrane electrode assembly 12 to the back pressure valve 38, is always kept at a predetermined value higher than the pressure of the gas in the gas discharge passage structure 28.

Namely, the pressure of the liquid fuel LP in the liquid fuel supply passage structure 24 in the anode electrode side of the electrolytic membrane 12a in the membrane electrode assembly 12 is always increased by a predetermined value higher than the pressure of the gas (carbon dioxide (CO₂) in this embodiment) in the micro passage member 20 that is the one end portion of the gas discharge passage structure 28 connected to the liquid fuel supply passage structure 24 in the anode electrode side of the electrolytic membrane 12a.

This means that a combination of the liquid fuel pressurizing unit 34 interposed in the liquid fuel supply passage structure 24, the liquid fuel returning passage structure 36 provided with the back pressure valve 38, and the pressure regulating unit 96 which is interposed in the liquid fuel supply passage structure 24 and which is normally opened by a pressure obtained by adding a predetermined pressure to the pressure of the gas from the branch passage 28′ of the gas discharge passage structure 28 provided with the pressure value 92 and pressure gauge unit 94, configures a gas-liquid separation accelerating structure 98 in this embodiment.

Therefore, the gas (carbon dioxide (CO₂) in this embodiment) produced as described above in the anode electrode side of the electrolytic membrane 12a in the membrane electrode assembly 12 is discharged easily into the micro passage member 20 that is the one end portion of the gas discharge passage structure 28 connected to the liquid fuel supply passage structure 24 in the anode electrode side of the electrolytic membrane 12a and is included hardly in the liquid fuel LP in the anode electrode side of the electrolytic membrane 12a in the membrane electrode assembly 12. Therefore, the discharging of the gas is accelerated. This acceleration is performed irrespectively of the posture of the fuel cell 90.

### Sixth Embodiment

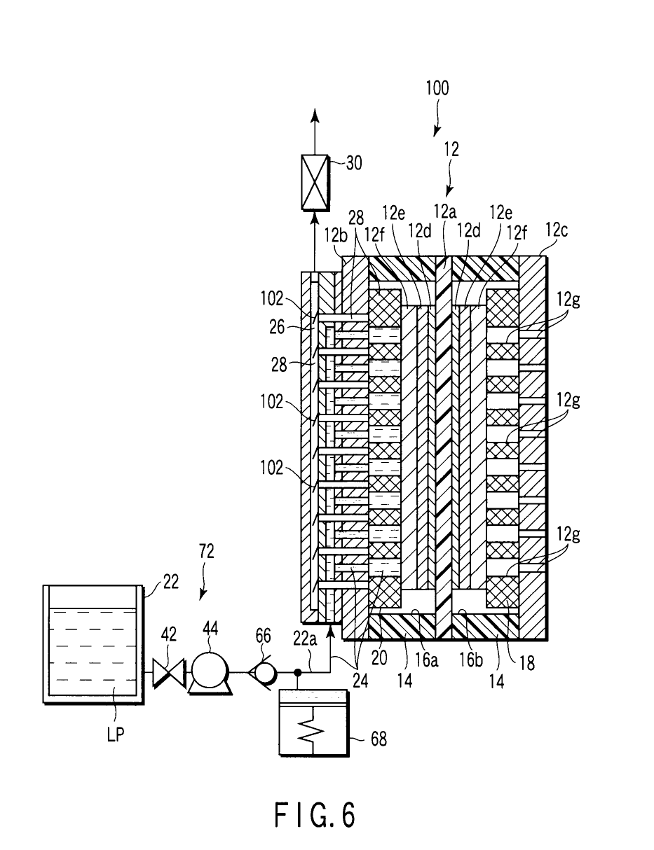

Most part of structural elements of a fuel cell 100 according to a sixth embodiment of the present invention shown in FIG. 6 is the same as that of the structural elements of the fuel cell 60 according to the third embodiment described hereinbefore with reference to FIG. 3. Therefore, the structural elements of the fuel cell 100 which are the same as those of the fuel cell 60 of the third embodiment are denoted by the same reference numerals as those denoting the structural elements of the fuel cell 60 corresponding to those of the fuel cell 100, and detailed explanation on these structural elements will be omitted.

The fuel cell 100 of this embodiment is different from the fuel cell 60 of the third embodiment described above with reference to FIG. 3 in that the liquid fuel supply pipe 22a of the liquid fuel supply passage structure 24 does not have a part with a reduced inner diameter, and valve members 102 are provided at the exits of the second through holes for the gas discharge passage structure 28 of the anode electrode 12b of the membrane electrode assembly 12 in the gas discharge pipe 26 of the gas discharge passage structure 28, instead of the back pressure 62 and pressure gauge unit 64 interposed in the gas discharge pipe 26 of the gas discharge passage structure 28 in the outside of the membrane electrode assembly 12.

The valve member 102 is made of a material with a predetermined elasticity, and is configured to be opened when the pressure of gas in the second through holes for the gas discharge passage structure 28 of the anode electrode 12b of the membrane electrode assembly 12 increases over a predetermined value, and to be closed when the pressure is decreased lower than the predetermined value.

In the fuel cell 100 configured as described above and according to the sixth embodiment, the valve member 102 is opened when the pressure of the gas (carbon dioxide (CO₂) in this embodiment) in the micro passage member 20 that is the one end portion of the gas discharge passage structure 28 connected to the liquid fuel supply passage structure 24 in the anode electrode side of the electrolytic membrane 12a becomes higher than a predetermined pressure of the liquid fuel LP included in the liquid fuel supply passage structure 22a from the liquid fuel pressurizing unit 68 to the anode electrode side of the electrolytic membrane 12a in the membrane electrode assembly 12. Namely, the pressure of the liquid fuel LP in the liquid fuel supply passage structure 24 in the anode electrode side of the electrolytic membrane 12a in the membrane electrode assembly 12 is always increased by a predetermined value higher than the pressure of the gas (carbon dioxide (CO₂) in this embodiment) in the micro passage member 20 that is the one end portion of the gas discharge passage structure 28 connected to the liquid fuel supply passage structure 24 in the anode electrode side of the electrolytic membrane 12a.

This means that a combination of the liquid fuel pressurizing unit 68 interposed in the liquid fuel supply passage structure 24 and the valve member 102 interposed in the gas discharge passage structure 28 configures a gas-liquid separation accelerating structure 104 in this embodiment.

Therefore, the gas (carbon dioxide (CO₂) in this embodiment) produced as described above in the anode electrode side of the electrolytic membrane 12a in the membrane electrode assembly 12 is discharged easily into the micro passage member 20 that is the one end portion of the gas discharge passage structure 28 connected to the liquid fuel supply passage structure 24 in the anode electrode side of the electrolytic membrane 12a, and is included hardly in the liquid fuel LP in the anode electrode side of the electrolytic membrane 12a in the membrane electrode assembly 12. Therefore, the discharging of the gas is accelerated. This acceleration is performed irrespectively of the posture of the fuel cell 100.

### Seventh Embodiment

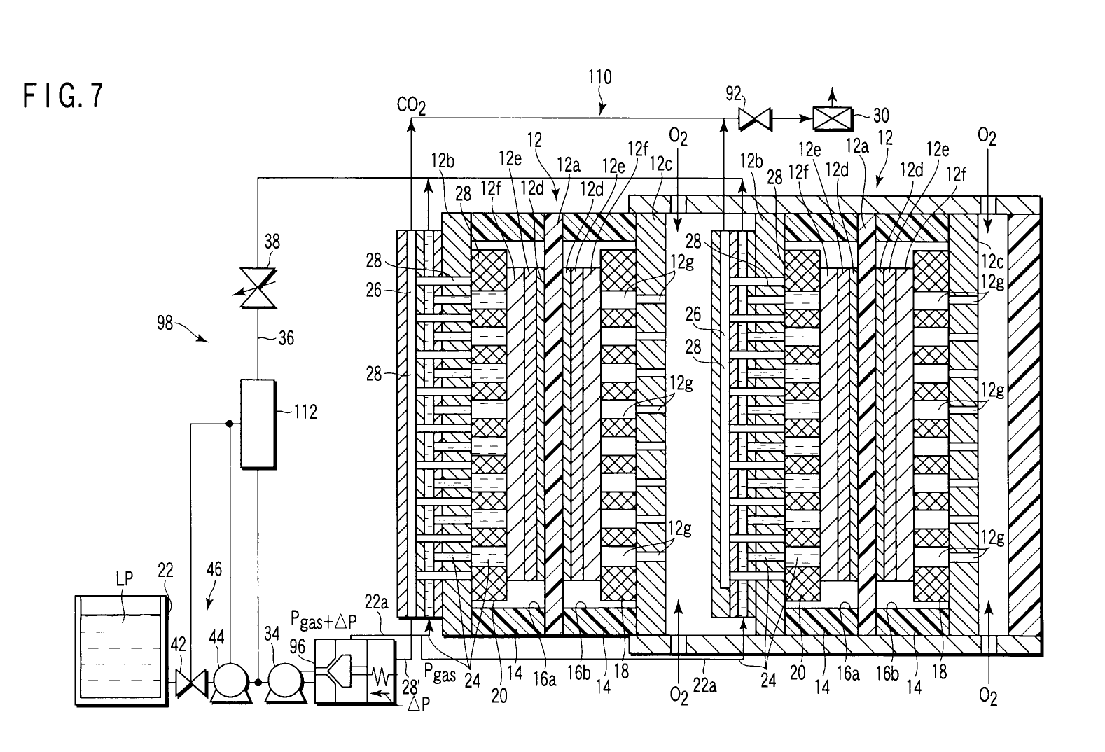

Most part of structural elements of a fuel cell 110 according to a seventh embodiment of the present invention shown in FIG. 7 is the same as that of the structural elements of the fuel cell 90 of the fifth embodiment described hereinbefore with reference to FIG. 5. Therefore, the structural elements of the fuel cell 110 which are the same as those of the fuel cell 90 of the fifth embodiment are denoted by the same reference numerals as those denoting the structural elements of the fuel cell 90 corresponding to those of the fuel cell 110, and detailed explanation on these structural elements will be omitted.

The fuel cell 110 of this embodiment is different from the fuel cell 90 of the fifth embodiment described with reference to FIG. 5 in that a liquid fuel concentration measuring unit 112 is interposed in the fuel returning passage 36.

The liquid fuel concentration measuring unit 112 is configured to measure the concentration of liquid fuel in the fuel returning passage 36 and to open and operate the on-off valve 42 and pressure pump 44 of the liquid fuel replenish unit 46 for a predetermined time when the measured liquid fuel concentration is lower than a predetermined value. Therefore, a fresh liquid fuel LP can be replenished from the liquid fuel tank 22 through the check valve 66 at every predetermined interval by the amount equivalent to that of the liquid fuel LP consumed in the anode electrode side of the electrolytic membrane 12a in the membrane electrode assembly 12.

Further, in the fuel cell 110 of this embodiment, many (two in FIG. 7) membrane electrode assemblies 12 are arranged in series. Therefore, the liquid fuel LP is supplied from one liquid fuel pressurizing unit 34 to the liquid fuel supply pipe 22a of the liquid fuel supply passage structure 24 of each membrane electrode assembly 12 through the pressure regulating unit 96, and one fuel returning passage 36 is connected to each liquid fuel supply pipe 22a. Further, the gas discharge pipes 26 of the gas discharge passage structures 28 of the membrane electrode assemblies 12 are combined, and are opened to the outer space through one back pressure valve 92 and an organic mater eliminating filter 30.

Therefore, the fuel cell 110 of this embodiment having many membrane electrode assemblies 12 can be operated in the similar manner to the fuel cell 90 of the fifth embodiment having one membrane electrode assembly 12 and described above with reference to FIG. 5.

### Eighth Embodiment

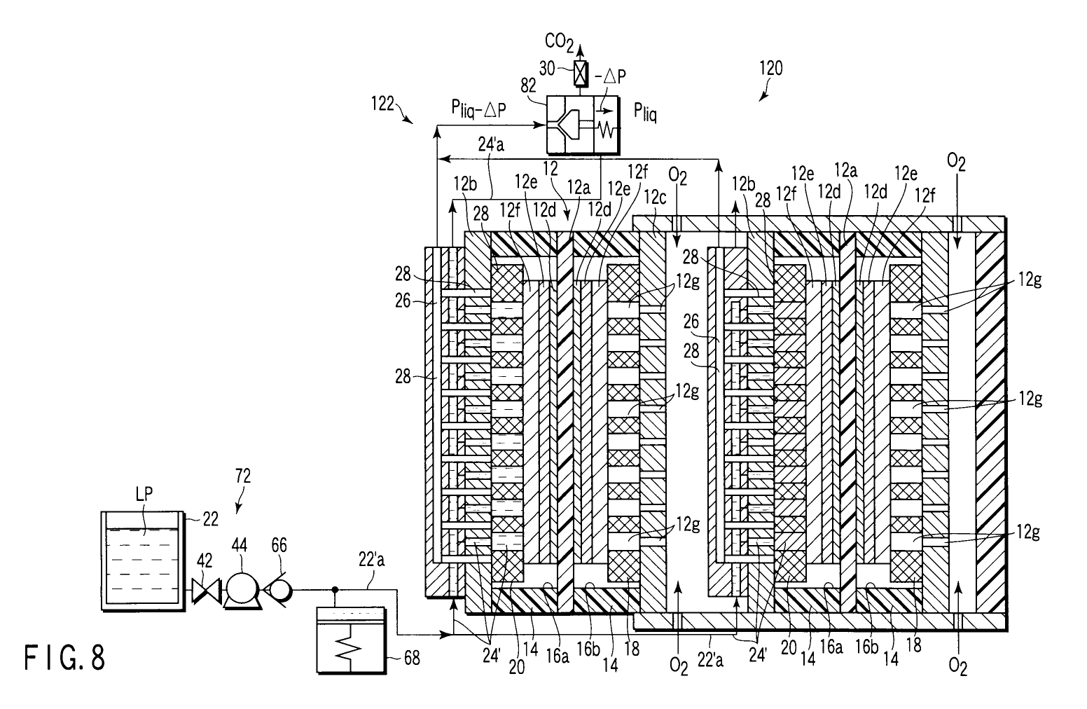

Most part of structural elements of a fuel cell 120 according to an eighth embodiment of the present invention shown in FIG. 8 is the same as that of the structural elements of the fuel cell 60 of the third embodiment described hereinbefore with reference to FIG. 3. Therefore, the structural elements of the fuel cell 120 which are the same as those of the fuel cell 60 of the third embodiment are denoted by the same reference numerals as those denoting the structural elements of the fuel cell 60 corresponding to those of the fuel cell 120, and detailed explanation on these structural elements will be omitted.

The fuel cell 120 of this embodiment is different from the fuel cell 60 of the third embodiment described above with reference to FIG. 3 in that, instead of the combination of the back pressure valve 62 and pressure gauge unit 64, the pressure regulating unit 82 used in the fuel cell 80 of the fourth embodiment described with reference to FIG. 4 is interposed in the gas discharge passage structure 28 in the outside of the membrane electrode assembly 12. Further, in this embodiment, a branch passage 24′a of the liquid fuel supply passage structure 24′ is connected to the pressure regulating unit 82.

The pressure regulating unit 82 is opened by a pressure obtained by subtracting a predetermined pressure from the pressure of the liquid fuel LP from the liquid fuel supply passage structure 24 and passes the gas in the gas discharge passage structure 28.

Therefore, in the fuel cell 120 configured as described above and according to the eighth embodiment, the pressure of liquid fuel LP included in the part of the liquid fuel supply passage structure 24′ from the liquid fuel pressurizing unit 68 to the anode electrode side of the electrolytic membrane 12a in the membrane electrode assembly 12, and in the part of the branch passage 24′a from the anode electrode side of the electrolytic membrane 12a in the membrane electrode assembly 12 to the pressure regulating unit 82, is always kept at a predetermined value.

The pressure regulating unit 82 discharges the gas from the gas discharge passage structure 28 to the outer space, before the pressure of the gas in the gas discharge passage structure 28, or in the micro passage member 20 that is the one end portion of the gas discharge passage structure 28 adjacent to the liquid fuel supply passage structure 24 in the anode electrode side of the electrolytic membrane 12a in the membrane electrode assembly 12, increases to the above described predetermined pressure of the liquid fuel LP.

Namely, the pressure of the liquid fuel LP in the liquid fuel supply passage structure 24′ in the anode electrode side of the electrolytic membrane 12a in the membrane electrode assembly 12 is always increased by a predetermined value higher than the pressure of the gas (carbon dioxide (CO₂) in this embodiment) in the micro passage member 20 that is the one end portion of the gas discharge passage structure 28 connected to the liquid fuel supply passage structure 24 in the anode electrode side of the electrolytic membrane 12a.

This means that a combination of the liquid fuel pressurizing unit 68 interposed in the liquid fuel supply passage structure 24′ and the pressure regulating unit 82 which is interposed in the gas discharge passage structure 28 and which is normally opened by a pressure obtained by subtracting a predetermined pressure from the pressure of the liquid fuel LP from the branch passage 24′ of the liquid fuel returning passage structure 24, configures a gas-liquid separation accelerating structure 122 in this embodiment.

Therefore, the gas (carbon dioxide (CO₂) in this embodiment) produced as described above in the anode electrode side of the electrolytic membrane 12a in the membrane electrode assembly 12 is discharged easily into the micro passage member 20 that is the one end portion of the gas discharge passage structure 28 connected to the liquid fuel supply passage structure 24′ in the anode electrode side of the electrolytic membrane 12a, and is included hardly in the liquid fuel LP in the anode electrode side of the electrolytic membrane 12a in the membrane electrode assembly 12. Therefore, the discharging of the gas is accelerated. This acceleration is performed irrespectively of the posture of the fuel cell 120.

Further, in the fuel cell 120 of this embodiment, many (two in FIG. 8) membrane electrode assemblies 12 are arranged in series. However, only one membrane electrode assembly 12 is provided with the branch passage 24′a of the liquid fuel supply passage structure 24′ for connecting to the pressure regulating unit 82, and any other membrane electrode assembly 12 is not provided with the branch passage 24′a as in the membrane electrode assembly 12 used in the fuel cell 60 of the third embodiment described above with reference to FIG. 3.

Therefore, the liquid fuel LP is supplied from the one liquid fuel pressuring unit 68 to the liquid fuel supply pipe 22′a of the liquid fuel supply passage structure 24′ of each membrane electrode assembly 12. Further, the gas discharge pipes 26 of the gas discharge passage structures 28 of the membrane electrode assemblies 12 are combined and opened to the outer space through the one pressure regulating unit 82 and organic mater elimination filter 30.

Therefore, the fuel cell 120 having many membrane electrode assemblies 12 and according to this embodiment can be operated in the similar manner to a case in which the fuel cell 60 of the third embodiment having one membrane electrode assembly 12 described with reference to FIG. 3 uses the pressure regulating unit 82 used in the fuel cell 80 of the fourth embodiment described with reference to FIG. 4 is used in the gas discharge passage structure 28, instead of the combination of the back pressure valve 62 and pressure gauge unit 64.

### Ninth Embodiment

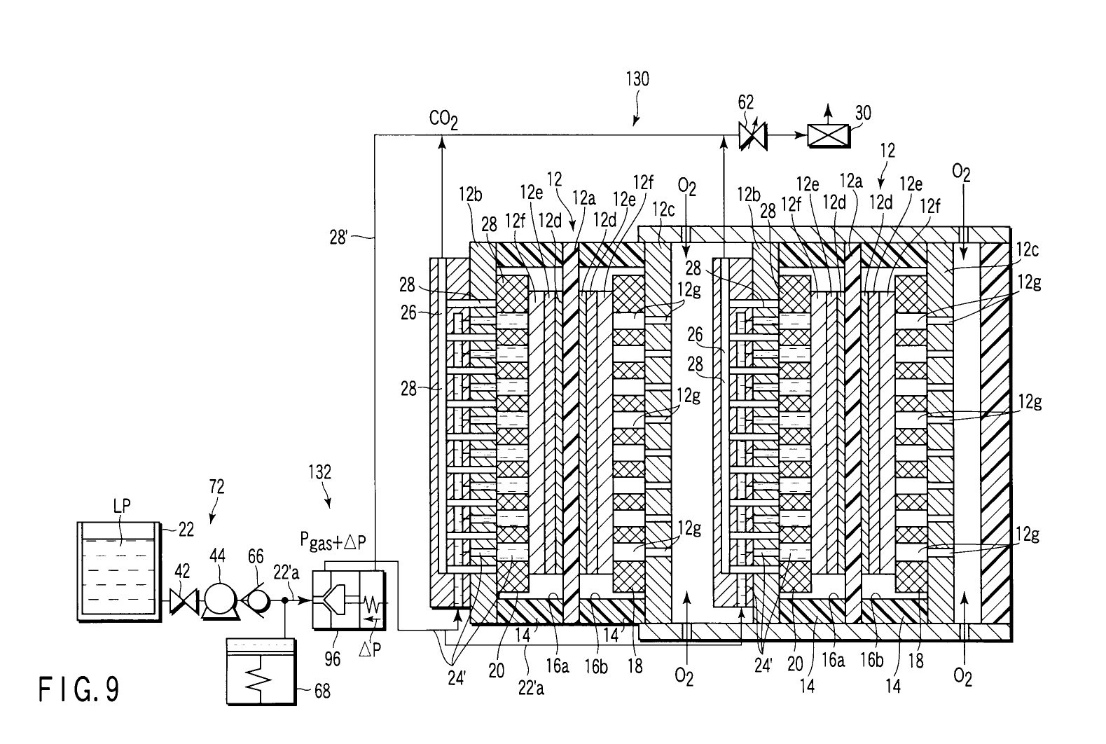

Most part of structural elements of a fuel cell 130 according to a ninth embodiment of the present invention shown in FIG. 9 is the same as that of the structural elements of the fuel cell 60 of the third embodiment described hereinbefore with reference to FIG. 3. Therefore, the structural elements of the fuel cell 130 which are the same as those of the fuel cell 60 of the third embodiment are denoted by the same reference numerals as those denoting the structural elements of the fuel cell 60 corresponding to those of the fuel cell 120, and detailed explanation on these structural elements will be omitted.

The fuel cell 130 of this embodiment is different from the fuel cell 60 of the third embodiment described with reference to FIG. 3 in that the pressure regulating unit 96 used in the fuel cell 90 of the fifth embodiment described with reference to FIG. 5 is interposed in the liquid fuel supply pipe 22′a of the liquid fuel supply passage structure 24′ between the membrane electrode assembly 12 and the liquid fuel pressurizing unit 68. Further, in this embodiment, the branch passage 28′ branched from the liquid fuel supply passage structure 28 is connected to the pressure regulating unit 96.

The pressure regulating unit 96 closes the liquid fuel supply pipe 22′a by a pressure obtained by adding a predetermined pressure to the pressure of the gas from the branch passage 28′, and stops the passing of liquid fuel LP in the liquid fuel supply pipe 22′a.

Therefore, in the fuel cell 130 of the ninth embodiment configured as described above, the pressure of the liquid fuel LP included in the part of the liquid fuel supply passage structure 24′ from the pressure regulating unit 96 to the anode electrode side of the electrolytic membrane 12a in the membrane electrode assembly 12, is always kept at a predetermined value larger than the pressure of the gas in the gas discharge passage structure 28.

Namely, the pressure of the liquid fuel LP in the liquid fuel supply passage structure 24′ in the anode electrode side of the electrolytic membrane 12a in the membrane electrode assembly 12 is always increased by a predetermined value higher than the pressure of the gas (carbon dioxide (CO₂) in this embodiment) in the micro passage member 20 that is the one end portion of the gas discharge passage structure 28 connected to the liquid fuel supply passage structure 24′ in the anode electrode side of the electrolytic membrane 12a.

This means that a combination of the liquid fuel pressurizing unit 68 interposed in the liquid fuel supply passage structure 24′ and the pressure regulating unit 96 which is interposed in the liquid fuel supply passage structure 24′ and which is normally opened by a pressure obtained by adding a predetermined pressure to the pressure of the gas from the branch passage 28′ of the gas discharge passage structure 28, configures a gas-liquid separation accelerating structure 132 in this embodiment.

Therefore, the gas (carbon dioxide (CO₂) in this embodiment) produced as described above in the anode electrode side of the electrolytic membrane 12a in the membrane electrode assembly 12 is discharged easily into the micro passage member 20 that is the one end portion of the gas discharge passage structure 28 connected to the liquid fuel supply passage structure 24′ in the anode electrode side of the electrolytic membrane 12a, and is included hardly in the liquid fuel LP in the anode electrode side of the electrolytic membrane 12a in the membrane electrode assembly 12. Therefore, the discharging of the gas is accelerated. This acceleration is performed irrespectively of the posture of the fuel cell 130.

Further, in the fuel cell 130 of this embodiment, many (two in FIG. 9) membrane electrode assemblies 12 are arranged in series. However, only one membrane electrode assembly 12 has the branch passage 28′ of the gas discharge passage structure 28 for connecting the pressure regulating unit 96, and any other membrane electrode assembly 12 does not have the branch passage 28′ of the gas discharge passage structure 28 for connecting the pressure regulating unit 96 as in the membrane electrode assembly 12 used in the fuel cell 60 of the third embodiment described above with reference to FIG. 3.

And, the liquid fuel LP is supplied from the one liquid fuel pressuring unit 68 to the liquid fuel supply pipe 22′a of the liquid fuel supply passage structure 24′ of each membrane electrode assembly 12 through the pressure regulating unit 96. Further, the gas discharge pipes 26 of the gas discharge passage structures 28 of the membrane electrode assemblies 12 are combined and opened to the outer space through the one back pressure valve 62 and organic mater elimination filter 30.

Therefore, the fuel cell 130 of this embodiment having many membrane electrode assemblies 12 can be operated in the similar manner as in a case in which the liquid fuel supply passage structure 24′ in the fuel cell 60 of the third embodiment having the one membrane electrode assembly 12 and described with reference to FIG. 3 uses the pressure regulating unit 96 used in the fuel cell 90 of the fifth embodiment described with reference to FIG. 5.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell comprising: a membrane electrode assembly including an electrolytic membrane, and an anode electrode and cathode electrode arranged in both sides of the electrolytic membrane;
a liquid fuel supply passage structure supplying liquid fuel to the anode electrode side of the electrolytic membrane;
an air supply passage structure supplying air to the cathode electrode side of the electrolytic membrane;
a gas discharge passage structure including one end portion which is connected to the liquid fuel supply passage structure in the anode electrode side of the electrolytic membrane and the other end portion which is opened to an outer space, the one end portion configured to separate gas and liquid from each other; and
a gas-liquid separation accelerating structure increasing a pressure of the liquid fuel in the liquid fuel supply passage structure in the anode electrode side of the electrolytic membrane higher than a pressure of a gas at the one end portion of the gas discharge passage structure, and discharging a gas which is produced from the liquid fuel in the anode electrode side of the electrolytic membrane and which is not passed through the electrolytic membrane, from the liquid fuel supply passage structure in the anode electrode side of the electrolytic membrane to the one end portion of the gas discharge passage structure.

2. The fuel cell according to claim 1, wherein the one end portion of the gas discharge passage structure includes a micro passage member including many micro passages, and the micro passage member has at least one of hydrophobic nature or water-repellency.

3. The fuel cell according to claim 1, wherein the liquid fuel supply passage structure includes a liquid fuel replenishing unit configured to replenish the liquid fuel to the liquid fuel supply passage structure, by an amount equivalent to that of the liquid fuel consumed in the anode electrode side of the electrolytic membrane.

4. The fuel cell according to claim 1, further comprising a liquid fuel returning passage structure having one end portion which is connected to the liquid fuel supply passage structure in the anode electrode side of the electrolytic membrane and the other end portion which is connected to the liquid fuel supply passage structure in the outside of the membrane electrode assembly, the liquid fuel returning passage structure returning the liquid fuel unreacted in the anode electrode side of the electrolytic membrane to the liquid fuel supply passage structure.

5. The fuel cell according to claim 4, wherein the gas-liquid separation accelerating structure includes a back-pressure valve provided in the liquid fuel returning passage structure.

6. The fuel cell according to claim 4, wherein the liquid fuel supply passage structure includes a liquid fuel replenishing unit configured to replenish the liquid fuel to the liquid fuel supply passage structure, by an amount equivalent to that of the liquid fuel consumed in the anode electrode side of the electrolytic membrane.

7. The fuel cell according to claim 6, wherein the gas-liquid separation accelerating structure includes a back-pressure valve provided in the liquid fuel returning passage structure.

8. The fuel cell according to claim 4, wherein the liquid fuel returning passage structure includes a liquid fuel concentration measuring unit configured to measure the concentration of the liquid fuel in the liquid fuel returning passage structure, and
the liquid fuel supply passage structure includes a liquid fuel replenish unit configured to replenish a fresh liquid fuel to the liquid fuel supply passage structure when the concentration of the liquid fuel measured by the liquid fuel concentration measuring unit is lower than a predetermined value.

9. The fuel cell according to claim 8, wherein the gas-liquid separation accelerating structure includes a back-pressure valve provided in the liquid fuel returning passage structure.

10. The fuel cell according to claim 1, wherein the liquid fuel supply passage structure includes a liquid fuel pressurizing unit configured to pressurize the liquid fuel to be supplied to the anode electrode side of the electrolytic membrane.

11. The fuel cell according to claim 10, wherein the liquid fuel supply passage structure includes a liquid fuel replenishing unit configured to replenish the liquid fuel to the liquid fuel supply passage structure, by an amount equivalent to that of the liquid fuel consumed in the anode electrode side of the electrolytic membrane.

12. The fuel cell according to claim 10, further comprising a liquid fuel returning passage structure having one end portion which is connected to the liquid fuel supply passage structure in the anode electrode side of the electrolytic membrane and the other end portion which is connected to the liquid fuel supply passage structure in the outside of the membrane electrode assembly, the liquid fuel returning passage structure returning the liquid fuel unreacted in the anode electrode side of the electrolytic membrane to the liquid fuel supply passage structure.

13. The fuel cell according to claim 12, wherein the gas-liquid separation accelerating structure includes a back-pressure valve provided in the liquid fuel returning passage structure.

14. The fuel cell according to claim 12, wherein the liquid fuel supply passage structure includes a liquid fuel replenishing unit configured to replenish the liquid fuel to the liquid fuel supply passage structure, by an amount equivalent to that of the liquid fuel consumed in the anode electrode side of the electrolytic membrane.

15. The fuel cell according to claim 14, wherein the gas-liquid separation accelerating structure includes a back-pressure valve provided in the liquid fuel returning passage structure.

16. The fuel cell according to claim 12, wherein the liquid fuel returning passage structure includes a liquid fuel concentration measuring unit configured to measure the concentration of the liquid fuel in the liquid fuel returning passage structure, and
the liquid fuel supply passage structure includes a liquid fuel replenish unit configured to replenish a fresh liquid fuel to the liquid fuel supply passage structure when the concentration of the liquid fuel measured by the liquid fuel concentration measuring unit is lower than a predetermined value.

17. The fuel cell according to claim 16, wherein the gas-liquid separation accelerating structure includes a back-pressure valve provided in the liquid fuel returning passage structure.

18. The fuel cell according to claim 1, wherein the gas-liquid separation accelerating structure includes a back-pressure valve provided in the liquid fuel returning passage structure.

19. The fuel cell according to claim 10, wherein the gas-liquid separation accelerating structure includes a back-pressure valve provided in the liquid fuel returning passage structure.

20. The fuel cell according to claim 11, wherein the gas-liquid separation accelerating structure includes a back-pressure valve provided in the liquid fuel returning passage structure.
